(19) United States
(12) Patent Application Publication
(10) Pub. No.: US 2009/0317507 A1
(43) Pub. Date: Dec. 24, 2009

(54) Press for producing powder based parts using compaction

(76) Inventors: Rom Eisenberg, Kfar Saba (IL); Doron Shabanov, Zur Igal (IL)

Correspondence Address: PLYGON TAMARISK LTD, P.O. Box 29746, Tel Aviv, 61297, IL

(21) Appl. No.: 12/461,828

(22) Filed: Aug. 26, 2009

Related U.S. Application Data
(63) Continuation of application No. PCT/IL2008/000213, filed on Feb. 19, 2008.
(60) Provisional application No. 60/903,295, filed on Feb. 26, 2007.

(51) Int. Cl. B28B 3/02

(52) U.S. Cl. 425/406

(57) ABSTRACT

A press for producing parts, such as high precision ceramic parts or powder metal parts, by compaction of material. The press comprises a frame having a longitudinal axis, a die and a punch assembly mounted on the frame, and a motion assembly adapted to move the punch assembly relative to the die along the axis. The punch assembly comprises a plate and a punch held by the plate and extending along the axis. The plate comprises a central portion via which the axis passes and distal portions on two sides of the central portion. The motion assembly comprises two linear motion mechanisms, each comprising a threaded shaft with a portion thereof received within one of the distal portions, and a nut assembly mounted on the threaded shaft and engaging the distal portion within which the threaded shaft is received. Each nut assembly comprises a nut housing surrounding a portion of the threaded shaft, and a plurality of ribbed rollers disposed therebetween in a planetary arrangement and engaging both. The rotational motion is provided to either both of the nut assemblies or both of the threaded shafts, causes linear motion of the punch assembly with the punch along the axis, for the compaction of powdered material contained within the die.

### RELATED APPLICATIONS

This application is a continuation of PCT Application No. PCT/IL2008/000213 filed on 19 Feb. 2008, which itself claims priority to U.S. application Ser. No. 60/903,295 filed on 26 Feb. 2007.

### FIELD OF THE INVENTION

This invention relates generally to a press for producing powder based parts using compaction, and more specifically to a press comprising a punch assembly having a punch, a die for containing therein powdered material to be compacted, and a motion assembly adapted to move the punch assembly with the punch relative to the die, so that the punch compacts powder within the die, thereby producing a powder based part.

### BACKGROUND OF THE INVENTION

Use of a press to produce powder based parts via compaction is a well known manufacturing technique. Performance factors of such presses are, inter-alia, the position accuracy provided to the punch, relative to the die, and uniform density of the part.

A press of the type mentioned above may, for example, be a hydraulic press, i.e. having a motion assembly that is powered by a hydraulic system. Such presses typically comprise a frame having a longitudinal axis; a die for containing therein powdered material to be compacted, mounted on the frame; a punch assembly mounted on the frame; and a motion assembly adapted to move the punch assembly relative to the die along the axis; the punch assembly comprising a plate and a punch held by the plate and extending along the axis; wherein the plate comprises a central portion via which the axis passes and distal portions on two sides of the central portion; the motion assembly comprising a hydraulic piston, mounted on the frame, disposed above and engaging the punch assembly; the hydraulic piston being adapted to move the punch assembly with the punch along the axis for compacting powdered material contained within the die.

The frame of a hydraulic press is a large reinforced structure, designed to support a heavy moving hydraulic piston, and to counter extremely large torque and tension forces on the punch assembly, that occur during impact of the punch with the powdered material contained within the die. To counter such forces the distal portions of the plate may have apertures formed therein, and the frame may comprise stabilizing members in the form of guide rods which are slidably disposed through those apertures. Thus, during motion of the punch assembly, the guide rods act to arrest motion, which is not parallel with the axis, of the plate and hence the punch assembly.

The central portion of the plate, while surrounded by the guide rods, is itself free of such, and thus the punch assembly may be considered to have an “open-center” arrangement. The open-center arrangement allows the punch to be mounted to the central portion of the plate, which is advantageous due to the high stability of the central portion enabled by the surrounding guide rods, thus improving the performance factors of the press mentioned above. The open-center arrangement also allows the possibility to mount additional punches to the central portion.

Additionally, the press may comprise an additional punch assembly, symmetrical and inverted with respect to the first punch assembly and positioned at the other side of the die therefrom.

In recent years “servo-hydraulic” presses, which are similar to the press described above, with the addition of servo-control of the punch assembly, have been used in the industry. The addition of servo-control of the punch assembly enables better performance of the press by allowing more accurate control of the punch assembly. Some typical presses on the market are the “TPA HS”, sold by Dorst Technologies (details of which can be found at the website http://www.dorst.de/dorst_seite/index-eng.html), and the “CA-NC-II”, sold by Osterwalder AG (details of which can be found at the website http://www.osterwalder.com/e/produkte/?sub=6&id=1).

### SUMMARY OF THE INVENTION

The present invention refers to a press for producing parts by compaction of material. The parts may be, for example, high precision ceramic parts or powder metal parts.

Thus, in accordance with a first aspect of the present invention there is provided a press comprising a frame having a longitudinal axis; a die for containing therein powdered material to be compacted, mounted on the frame; a punch assembly mounted on the frame; and a motion assembly adapted to move the punch assembly relative to the die along the axis; the punch assembly comprising a plate and a punch held by the plate and extending along the axis; wherein the plate comprises a central portion via which the axis passes and distal portions on two sides of the central portion; the motion assembly comprising two linear motion mechanisms each comprising a threaded shaft with a portion thereof received within one of the distal portions, and a nut assembly mounted on the threaded shaft and engaging the distal portion within which the threaded shaft is received; each nut assembly comprising a nut housing surrounding a portion of the threaded shaft, and a plurality of ribbed rollers disposed therebetween in a planetary arrangement and engaging both; wherein rotational motion provided to either both of the nut assemblies or both of the threaded shafts, causes linear motion of the punch assembly with the punch along the axis, for the compaction of powdered material contained within the die.

Such roller screws having a planetary arrangement of rollers are produced and marketed, for example, by Exlar Corporation of Chanhassen, Minn. and the SKF Group of AB SKF Sweden. Some of the various types of roller screws with different internal construction that can produce similar motion, examples of which being the “planetary roller screw” type, having threaded rollers, or the “recirculating roller screw” type, having grooved rollers, both of which are sold by SKF, may be found at the website www.linearmotion.skf.com.

U.S. Pat. No. 6,543,121, for example, discloses a riveting apparatus which uses roller screws, which are operated by a servo-controlled electric motor.

Notably, linear motion mechanisms of the type described above are significantly lighter than hydraulic pistons designed to produce a similar powder based part. Therefore an advantage of the use of roller screws in accordance with the first aspect of the present invention is that it enables a press built in accordance therewith to have a more compact frame than that of a hydraulic press designed to produce a similar powder based part. While having a more compact frame, the use of two linear motion mechanisms may still provide compaction forces equivalent to those provided by a hydraulic press designed to produce a similar powder based part, while retaining the benefits of an open-center arrangement.

Each linear motion mechanism may have a threaded shaft and nut assembly that is right-hand threaded or left-hand threaded. However, it is advantageous for a motion assembly in accordance with a press of the present invention to have at least one right-hand threaded shaft and nut assembly and at least one left-hand threaded shaft and nut assembly, so that one linear motion mechanism will comprise clockwise rotating parts and the other will comprise counterclockwise rotating parts, thereby creating what will be called, for the purposes of the specification and the claims, “opposing forces” during operation.

The advantage of having the opposing forces, is that extremely large torque and tension forces, created during operation of a press of the present invention, may be substantially balanced out. Additionally, due to the engagement of the linear motion mechanisms with the plate, the opposing forces contribute to the absorption of the undesired torques and tension forces within the punch assembly itself, and thus a more compact frame may be used than one needed for a hydraulic presses designed to produce a similar powder based part.

In accordance with this aspect the motion mechanism may comprise a motor. The linear motion mechanisms are capable of producing high compaction forces with rotational motion provided thereto by a relatively compact motor. The compact motor may consequently be mounted on the punch assembly and move therewith. An advantage of mounting a motor on the punch assembly, is that it enables the use of a simple transmission mechanism. Such a compact motor may, for example, be an electric motor. Additionally, the motor may be servo-controlled.

In accordance with this aspect the motion the motor may comprise a plurality of motors adapted to provide rotational motion to one or more linear motion mechanisms. There may be one motor for each linear motion mechanism. Accordingly, there may be more than one motor mounted on the punch assembly. A benefit of which may be a simplified transmission mechanism.

Alternatively, in accordance with this aspect the motor may comprise a single motor adapted to provide rotational motion to the above-mentioned two linear motion mechanisms. The single motor may also be mounted on the punch assembly. Both of these features also contribute to the ability to use a simple transmission mechanism to be used for delivering motion to the linear motion mechanisms. In such a case, the transmission mechanism may be adapted to receive a single directional rotational motion from the rotor of a single motor and to provide clockwise rotational motion to one of the linear motion mechanisms and counterclockwise rotational motion to the other, thus providing opposing directions of rotation thereto.

The opposing directions of rotation of the two linear motion mechanisms may facilitate a portion of the plate, at a midpoint therebetween, to have better stability than other portions of the plate. Thus the axis and hence the punch may be disposed, advantageously, along this mid-point, in order to provide the punch optimal stability due to the open-center arrangement and/or the opposing directions of rotation of the linear motion mechanisms.

Alternatively, the punch may not be disposed at a mid-point between the two linear motion mechanisms. This disposition may be advantageous when a press of the present invention comprises more than one punch.

A press in accordance with aspects of the present invention may comprise at least one additional punch assembly and corresponding motion assembly therefor, and the frame may have at least one additional axis which the additional assemblies may be associated with. In such case, each axis and each of the assemblies and their elements may be referred to with an identifying adjective, for example, a first punch assembly moved by a first motor, a second punch assembly moved along the second axis by a second motor, etc. The additional axis/axes may be parallel, and collinear or adjacent with the first axis.

The second punch assembly may be inverted with respect to the first punch assembly with the die plate disposed therebetween.

The second punch assembly may disposed such that the first punch assembly is disposed between the second punch assembly and the die. In this case the second punch may be an elongated punch, in order to compact the powder within the die. Additionally, in this case the first axis may be collinear with the second axis, wherein the first punch may have an aperture formed therein to allow the movement of the second punch therethrough. Alternatively, the first axis and second axis may be parallel and adjacent with each other, wherein the first plate may have an aperture, via which the second axis passes, to allow the second punch to pass therethrough in order to compact the powder within the die.

The first and second punch assemblies may have collinear linear motion mechanisms, enabling the collinear shafts thereof to be shared. For example, each of the first linear motion mechanisms may be collinear with one of each of the second linear motion mechanisms and thus the shafts of each pair of collinear mechanisms may constitute portions of one common shaft.

In a case where a press of the present invention comprises more than one punch assembly and motion assembly, the motion assemblies may be adapted to provide synchronized motion and independent motion to the punch assemblies. Furthermore, the linear motion mechanisms may be constructed so that each nut assembly rotates and moves in linear motion with respect to the die plate and the threaded shaft is static with respect thereto, in which case the motion mechanism provides rotational motion to the nut assemblies. Alternatively, the linear motion mechanisms may be constructed so that each threaded shaft rotates and moves in linear motion with respect to the die plate and the nut assembly is static with respect thereto, in which case the associated motor provides rotational motion to the threaded shafts.

The press may include a control system by which a user may operate the press.

The press may include a sensor for detection of compaction force and/or displacement of the punch and/or like factors, and transmit such data to the control system or motion mechanism.

In accordance with a further aspect of the present invention, there is provided a press wherein the motion assembly comprises two linear motion mechanisms and a single motor adapted to provide rotational motion to both linear motion mechanisms.

In accordance with any of the aspects of the present invention, there may be more than two linear motion mechanisms for each punch assembly.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a perspective view of a press according to a first embodiment of the present invention;

FIG. 1B is a perspective view of a plate of the press in FIG. 1A;

FIG. 1C is a side view of a motion assembly of the press in FIG. 1A;

FIG. 1D is a top view of the motion assembly in FIG. 1C;

FIG. 2A is a perspective view of a threaded shaft and a nut assembly, which constitute part of a linear motion mechanism of the press in FIG. 1A;

FIG. 2B is a perspective view of a first rotary housing for the threaded shaft and nut assembly in FIG. 2A;

FIG. 2C is a side view of the first rotary housing shown in FIG. 2B, fastened to the threaded shaft and nut assembly in FIG. 2A;

FIG. 2D is a side view of rotating elements of the linear motion mechanism of the press in FIG. 1A, and a large-gear-wheel attached thereto;

FIG. 2E is a perspective view of a second rotary housing of the linear motion mechanism in FIG. 2D;

FIG. 2F is a perspective view of a thrust bearing ring of the linear motion mechanism in FIG. 2D;

FIG. 2G is an perspective view of a thrust bearing ring of the linear motion mechanism in FIG. 2D;

FIG. 2H is a perspective view of the linear motion mechanism in FIG. 2D, further comprising some non-rotational parts;

FIG. 2J is a perspective view of the entire linear motion mechanism in FIG. 1A, with a large-gear-wheel attached thereto;

FIG. 3A is a schematic side view of a portion of a press according to a further embodiment of the present invention, in a non-operational state; and

FIG. 3B is a schematic side view of the portion of the press illustrated in FIG. 3A, in an operational state.

### DETAILED DESCRIPTION OF EMBODIMENTS

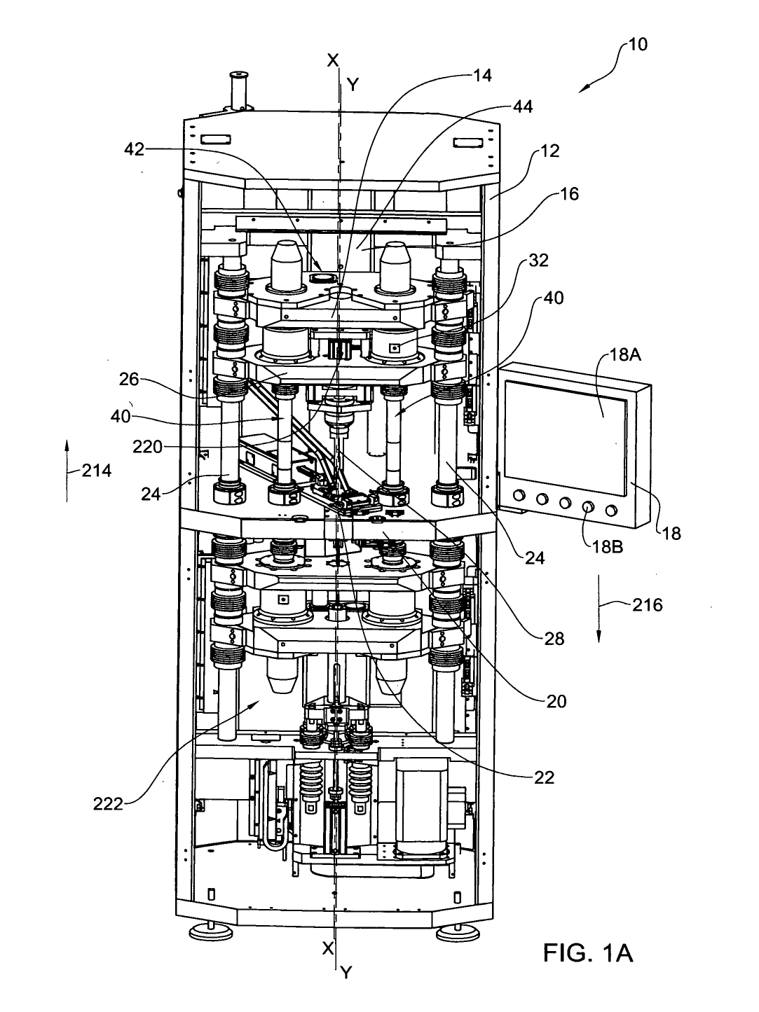

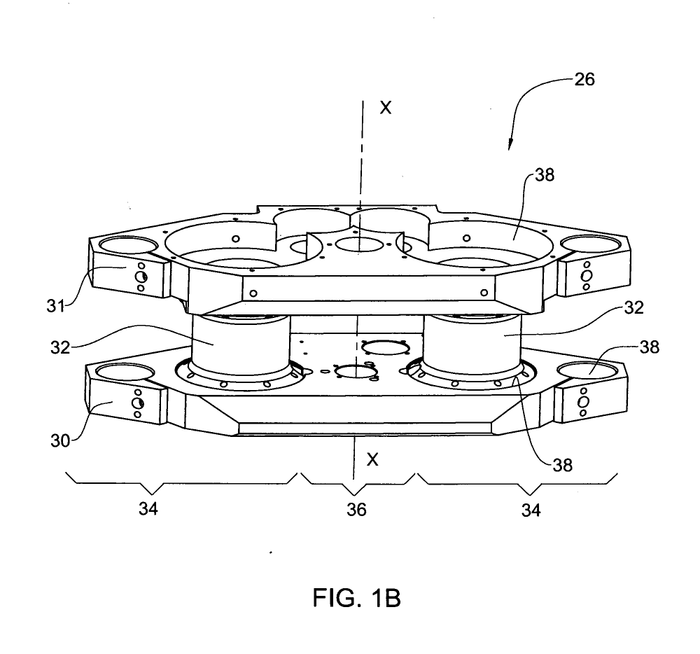

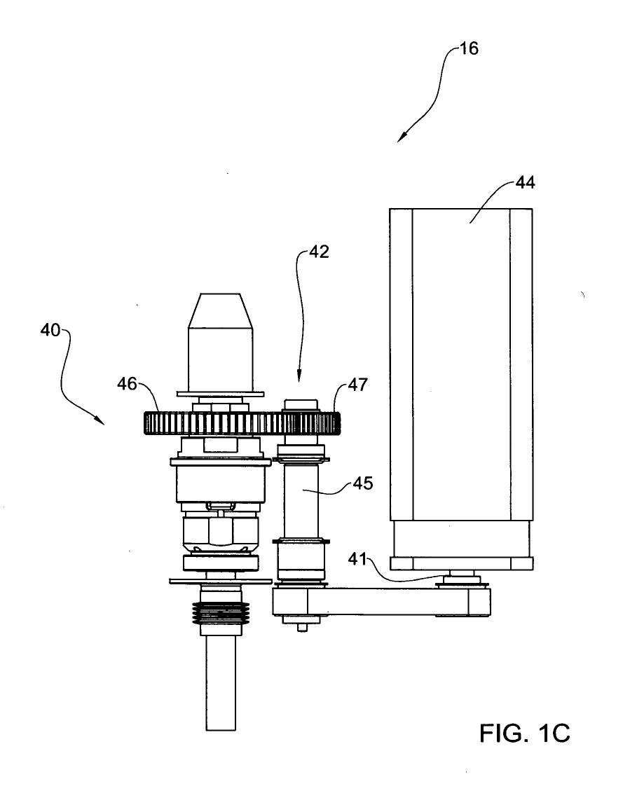

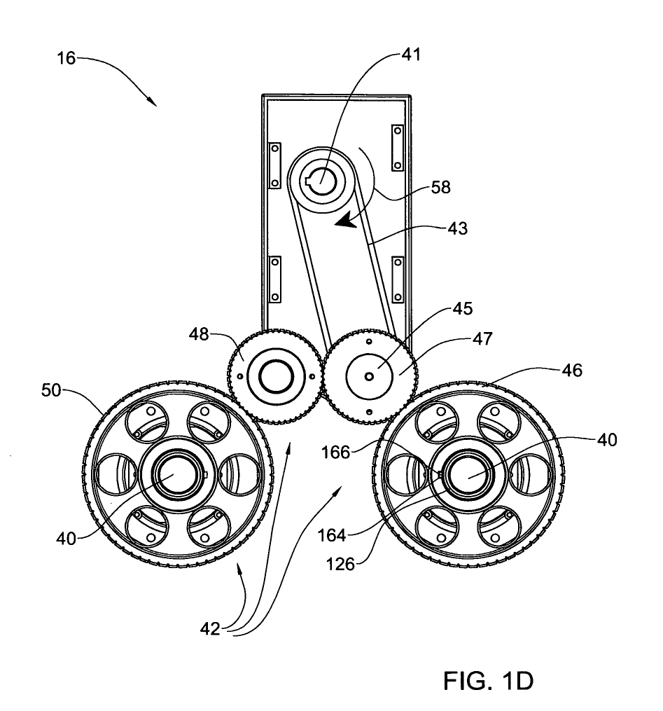

Turning attention first to FIG. 1A, there is shown one example of a press according to the present invention, generally designated 10. The press 10 comprises a frame 12 having an axis X, a punch assembly 14 mounted on the frame 12, a motion assembly 16 adapted to move the punch assembly 14 in a linear motion along the axis X, and a control system 18 mounted on the frame 12 for operating the motion assembly 16.

The press 10 further comprises a die plate 20 oriented perpendicular relative to the axis X and statically mounted on the frame 12, and a die 22 via which the axis X passes and mounted on the frame 12 via the die plate 20. The die is adapted for containing therein powdered material (not seen) to be compacted.

The frame 12 comprises stabilizing members in the form of a pair of static guide rods 24 which engage the die plate 20 and the punch assembly 14.

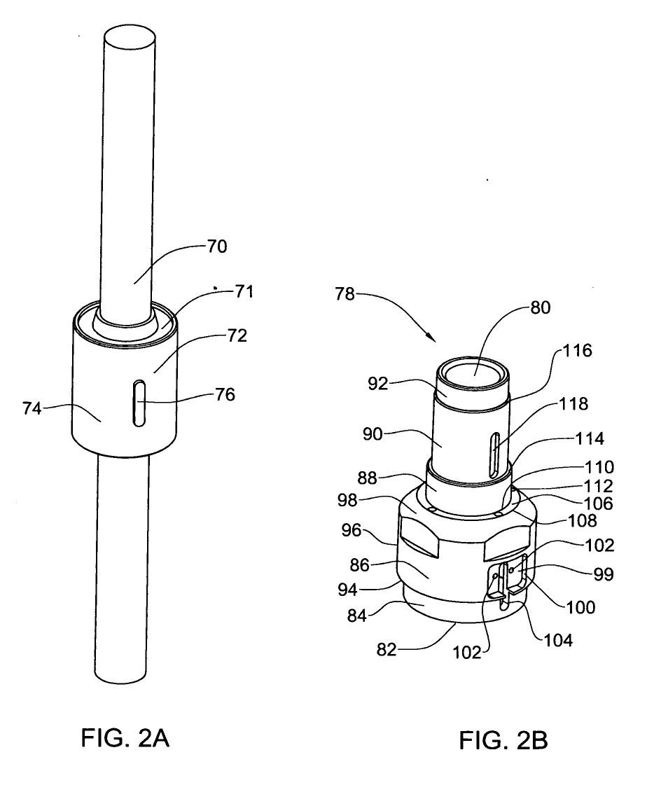

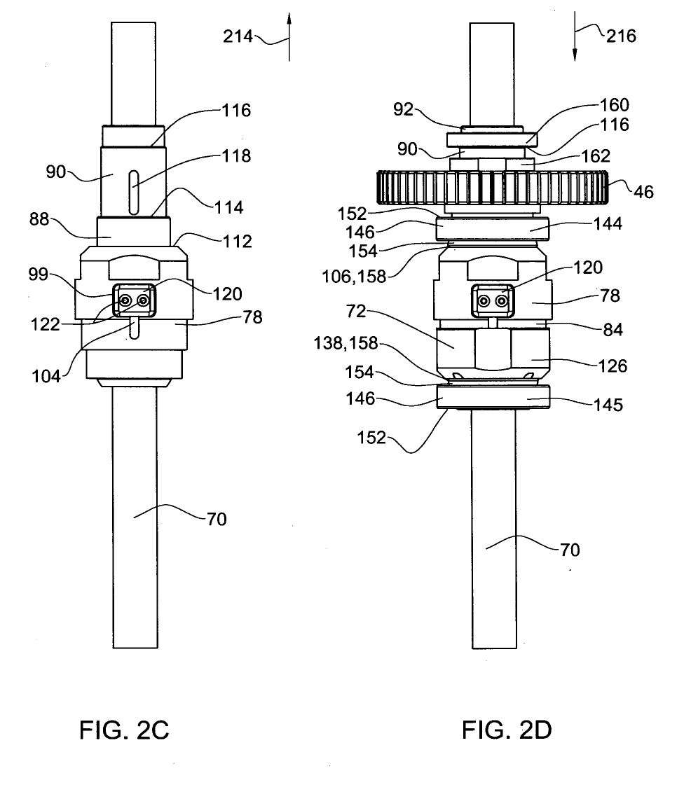

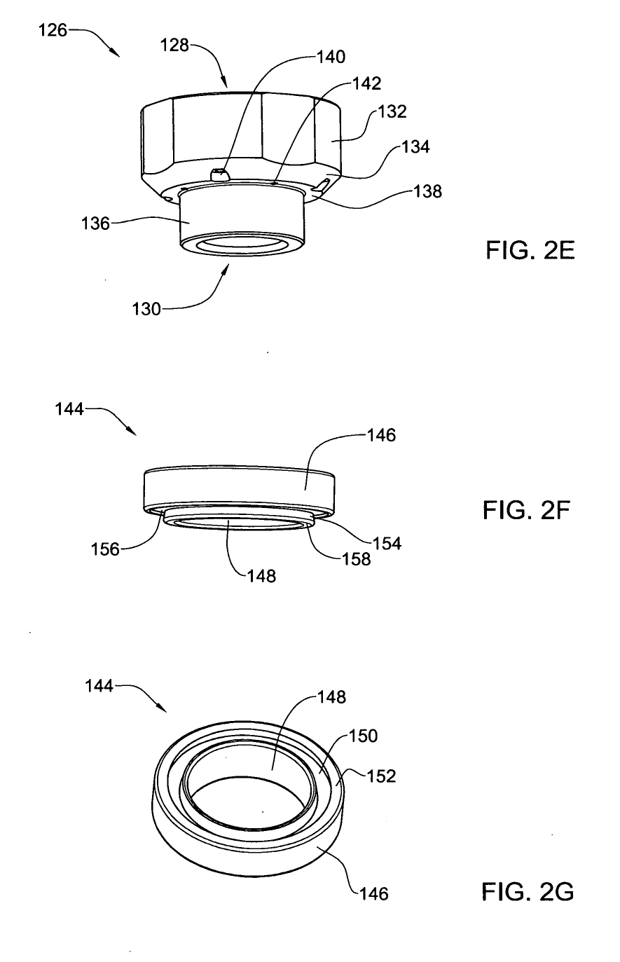

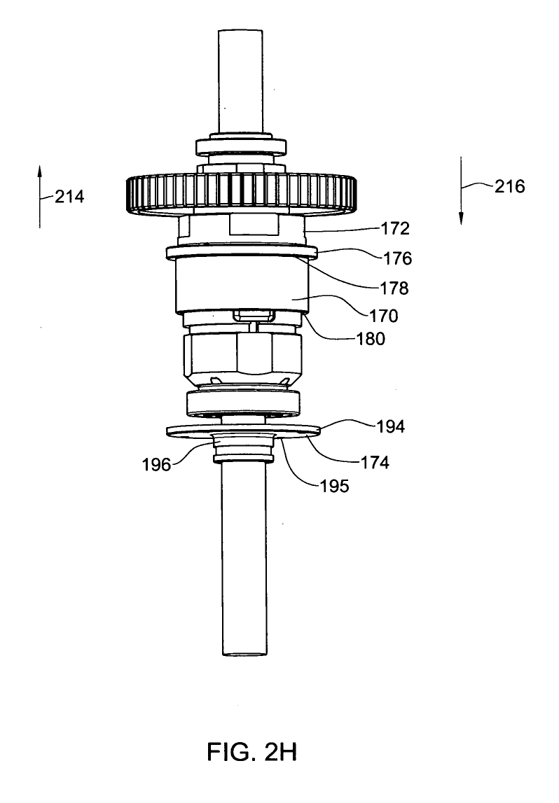

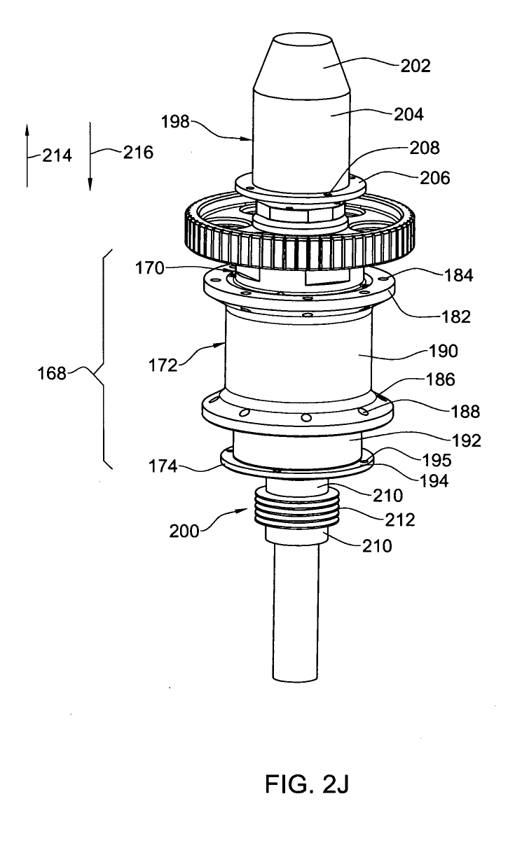

The punch assembly 14 comprises a plate 26 (best seen in FIG. 2B) oriented perpendicular relative to the axis X, and a punch 28 held thereby and extending along the axis X above the die 22 for insertion therein.

Turning attention briefly to FIG. 1B, the plate 26, in this example, comprises of a first planar member 30, a second planar member 31 spaced from the first planar member 30, and two cylindrical sleeve members 32 fixed therebetween. The plate 26, may be theoretically divided into a central portion 36 via which the axis X passes and distal portions 34 on two sides of the central portion 36. The distal portions 34 include the sleeve members 32 and portions of the planar members (30, 31), and have apertures 38 formed therein. Some of the apertures 38 slidably receive the guide rods 24 (FIG. 1A) of the frame 12. The cylindrical sleeve members 32 are fixed to the distal portions 34 of the planar members (30, 31) and are concentric with some of the apertures 38. The sleeve members 32 are adapted for engaging elements of the motion assembly 16 (FIG. 1A) as will be described hereinafter. It should be noted that according to other examples of a press according to the present invention the plate may be of various shapes, for example a single planar member with the cylindrical sleeves formed therein, etc.

Referring now to FIGS. 1A to 1D, the motion assembly 16 comprises two linear motion mechanisms 40 (only one of which can be seen in the FIG. 1C) which engage the sleeve members 32 (see FIGS. 1A and 1B) of the plate 26 and are parallel with the axis X (see FIGS. 1A and 1B) which is disposed therebetween, a transmission mechanism 42 engaging the linear motion mechanisms 40, and a single motor 44 (FIGS. 1A and 1C, partially seen in FIG. 1D) mounted on the plate 26 for providing rotational motion to the two linear motion mechanisms 40 via the transmission mechanism 42. It should be mentioned, that in FIG. 1D the only significant portion of the motor 44 that is visible is a rotor element 41.

The transmission mechanism 42 (seen most clearly in FIGS. 1C and 1D) engages both of the linear motion mechanisms 40 and the motor 44, and comprises a belt 43 (FIG. 1D) adapted for rotation by the rotor element 41; a transmission shaft 45 capable of being rotated by the belt 43; a first toothed small-gear-wheel 47 mounted on the transmission shaft 45; a first toothed large-gear-wheel 46 mounted on one of the linear motion mechanisms 40 and engaging the first small-gear-wheel 47; a second toothed small-gear-wheel 48 engaging the first small-gear-wheel 47; and a second toothed large-gear-wheel 50 mounted on one of the linear motion mechanisms 40 and engaging the second small-gear-wheel 48. As can be seen in FIG. 1A, all of the above-mentioned gear-wheels (46, 47, 48 and 50) are received within the apertures 38 of the second planar member 31 of the plate 26.

It should be noted that during operation of the transmission mechanism 42, the rotor element 41 is rotated clockwise, as shown by arrow 58 in FIG. 1C, then the first small-gear-wheel 47 and second toothed large-gear-wheel 50 will rotate clockwise, while the second small-gear-wheel 48 and first large-gear-wheel 46 will rotate counterclockwise. Whereas if the rotor element 41 is rotated counterclockwise, each of the wheel elements (44, 46, 48, and 50) will rotate in the opposite direction to that mentioned above. Therefore, regardless of the direction that the rotor element 41 is rotated, one of the large-gear-wheels (46 and 50) will rotate in a clockwise direction and the other will rotate in a counterclockwise direction, which in turn will deliver opposing rotational motion to each of the linear motion mechanism 40.

It should also be mentioned, that in other envisioned examples of a press of the present invention there may be provided a transmission mechanism comprising different elements or no transmission mechanism at all, in which case the motor may directly engage the linear motion mechanism/s. Alternatively there may be one motor allocated to a single linear motion mechanism, or alternatively more than two linear motion mechanisms. In such cases there may be more than one motor mounted on the punch assembly for motion therewith.

Turning now to FIGS. 2A-2J, the construction of one of the linear motion mechanisms 40, will be described in detail.

Referring first to FIG. 2A, the innermost components of one of the linear motion mechanisms are, inter alia, a right-hand threaded shaft 70 and a right-hand nut assembly 72 mounted thereon, sold by the SKF Group under the name “Planetary roller screw”. The threaded shaft 70 is female-threaded (threading not shown) and is statically fixed to the die plate 20 and the frame 12, and has a portion thereof received within one of the apertures 38 (FIG. 1B) formed in one of the distal portions 34 of the plate 26 (FIG. 1A). The right-handed nut assembly 72 engages the distal portion 34 (FIG. 1B) within which the portion of the threaded shaft 70 is received. The nut assembly 72 is in the form of a planetary roller nut and comprises a nut housing 74 with an internal female (not shown), an oval-shaped key 76 disposed on the exterior of the nut housing 74, and a plurality of ribbed rollers (not shown) in the form of threaded rollers disposed in a planetary arrangement between the threaded shaft 70 and the nut housing 74. The ribs of the ribbed rollers (not shown) engage both the female thread of the shaft 70 and the nut assembly 72. The nut housing 74 also comprises a recess in the form of a circular track 71 at each axial end thereof.

During rotation of the linear motion mechanism 40, a force tangential to the nut housing 74 is applied to the oval-shaped key 76, causing rotational motion of the nut assembly 72, which is converted into linear motion of the nut assembly 72 along the static threaded shaft 70. The above-described tangential force applied to the key 76 is enabled by a number of components which will now be described.

Referring to FIG. 2B, there is illustrated a substantially cylindrical first rotary housing, generally designated 78, which is adapted to be mounted on the nut assembly 72. The first rotary housing 78 has an open top end 80 and an open bottom end 82, through which the threaded shaft 70 can be inserted. The first rotary housing 78 can be divided into five substantially cylindrical sections of different diameter, namely, a first cylindrical section 84, a second cylindrical section 86, a third cylindrical section 88, a forth cylindrical section 90 and a fifth cylindrical section 92. The first section 84 is disposed adjacent to the open bottom end 82 and has an inner diameter larger than the exterior diameter of the nut housing 74. The second section 86 extends from the first section 84, being separated thereby by a first shoulder 94, and comprises a substantially cylindrical portion 96 and a tapered portion 98 extending therefrom. The cylindrical portion 96 is formed with a groove 99 therein. The groove 99 has a substantially rectangular edge 100, and two apertures 102 disposed on either side of a first oval-shaped slot 104 formed therein. The first slot 104 also extends partially into the first section 84. The tapered portion 98 ends at flat surface 106, which extends between a first edge 108 and a second edge 110 having a smaller diameter than the first edge 108. The flat surface 106 comprising a plurality of apertures 112 formed therein. The third section 88 extends from the second edge 110 to a second shoulder 114. The forth section 90 extends from the second shoulder 114 to a third shoulder 116, and has an outer diameter smaller than that of the third section 88. The forth section has a second oval-shaped slot 118 formed therein. The fifth section 92 extends from the third shoulder 116 to the open top end 80 and has an outer diameter smaller than that of the fourth section 90.

In FIG. 2C, the first rotary housing 78 is shown mounted on the threaded shaft 70 and the nut assembly 72 which it is secured thereto by a fastening element 120. The fastening element 120 is shaped to fit inside the rectangular edge 100 of the groove 99 and is disposed therein. The fastening element 120 further comprises two apertures 122 concentric with the two apertures 102 of the groove 99. When the first rotary housing 78 is mounted on the nut assembly 72, the oval-shaped key 76 (FIG. 2A) extends partially into the first oval-shaped slot 104, arresting motion between the first rotary housing 78 and nut assembly 72. Additionally, two bolts (not shown) are inserted into the apertures 122 and 102 which surround the oval-shaped key 76 on two sides, providing further structural strength to the joining of the first rotary housing 78 and nut assembly 72.

Turning attention now to FIGS. 2B and 2D, a number of elements are shown mounted on the first rotary housing 78, including: a substantially cylindrical second rotary housing 126 mounted on the first section 84; a thrust bearing ring 144 mounted on the third section 88; a large-gear-wheel 46, which is a part of the transmission mechanism 42 (FIGS. 1C and 1D), mounted on the fourth section 90 and engaging the thrust bearing ring 144; a washer 162 mounted on the fourth section 90 for arresting axial motion of the large-gear-wheel 46; and an axial bearing ring 160 seated on the third shoulder 116 and encircling the fifth section 92.

Referring now to FIG. 2E, the second rotary housing 126 has an open top end 128, an open bottom end 130, through which the threaded shaft 70 can be inserted. The second rotary housing 126 comprises a seating portion 132 within which the first cylindrical section 84 of the first rotary housing 78 is seated, a tapered portion 134 extending from the seating portion 132, a tubular portion 136, and a level surface 138 extending between the seating portion 132 and the tubular portion 136. The tapered portion 134 and the level surface 138 both have a plurality of apertures formed therein designated as 140 and 142, respectively.

In FIGS. 2F and 2G, the thrust bearing ring 144 is shown in more detail. The ring 144 comprises an outer edge 146, an inner edge 148, a plurality of tapered roller bearings (not shown) disposed inside the ring 144 between the outer edge 148 and inner edge 148, a recessed top track 150 disposed adjacent to the inner edge 148, a level top surface 152 disposed between the top track 150 and the outer edge 146, an annular ring 154 and a recessed bottom track 156 disposed between the annular ring 154 and the outer edge 146. The annular ring 154 comprises a level bottom surface 158.

It can be seen from FIG. 2D that the level bottom surface 158 of the thrust bearing ring 144 engages the flat surface 106 (best seen in FIG. 2B) of the first rotary housing 78, and that another identical thrust bearing ring 145 is mounted on the second rotary housing 126 with it's level bottom surface 158 engaging the level surface 138 (best seen in FIG. 2B) thereof. Notably, both the first rotary housing 78 and the second rotary housing 126 firmly engage the inner edges 148 of the rings 144 and 145.

As per standard thrust bearing ring operation: an object mounted inside a thrust bearing ring (144, 145) applies linear and rotational force to the annular ring 154 and the inner edge 148 thereof; the rotational motion of the object is neutralized by the tapered bearings inside the thrust bearing ring (144, 145), and is therefore not transmitted to the outer edge 146 or top surface 152 of the thrust bearing ring (144, 145); linear force, however, is transmitted to the level top surface 152 by the tapered bearings, which does not rotate but applies linear or thrusting force to objects adjacent thereto.

The large-gear-wheel 46 further comprises a slot 164 (FIG. 1D). During mounting of the large-gear-wheel 46 to the rotary housing 126, an oval-shaped key 166 (FIG. 1C) is inserted into the second oval-shaped slot 118 (FIG. 2B) and the large-gear-wheel's slot 164 is slotted there on.

Therefore, with reference to FIG. 2D, rotational motion of the large-gear-wheel 46, results in corresponding rotation of all the elements shown, with the exception of the above-mentioned portions of the bearing rings (144, 145), around the threaded shaft 70.

Referring now to FIGS. 2H and 2J, one of the sleeve members 32 of the plate 26 (FIGS. 1A and 1B) is shown with a portion of the threaded shaft 70 received therein. The sleeve member 32 comprises a first sleeve element 170 mounted on the thrust bearing ring 144 (FIG. 2D), and a second sleeve element 172 mounted on the first sleeve element 170. The first sleeve 170 further comprises an external annular rim 176 having apertures 178 formed therein, a lower edge 180, and an internal annular rim (not shown). The second sleeve 172 comprises a first flanged portion 182 having apertures 184 formed therein, a second flanged portion 186 having apertures 188 formed therein, a large cylindrical portion 190 extending between the flanged portions 182 and 186, and a small cylindrical portion 192 extending longitudinally from the second flanged portion 186. Additionally the second sleeve 172 has an internal shoulder (not shown) in the small cylindrical portion 192, which is adapted to seat the thrust bearing ring 145 thereon.

For safety considerations, there is a stopper cap 198 seated on the axial bearing ring 160 via an internal shoulder (not shown), an annular plate 174 mounted on the threaded shaft 70 and engaging the second sleeve 172, and a stopper sleeve 200 mounted the annular plate 174, all of which are designed to move parallel to the axis X with the first rotary housing 78 and arrest excessive linear motion thereof. The stopper cap 198 comprises a tapered portion 202, a central portion 204 and a flanged portion 206 having a plurality of apertures 208. The stopper cap 198 moves along the axis X with the first rotary housing 78, but does not significantly rotate due to the axial bearing ring 160 neutralizing the rotational motion therebetween. The annular plate 174 has a flanged portion 194 with apertures 195 formed therein, and a tube portion 196. The annular plate 174 is then bolted (not shown) to the apertures 38 of the first planar member 30, via its apertures 195. The stopper sleeve 200 is mounted on the tube portion 196 of the annular plate 174 and comprises two tubular portions 210 with a compressible section 212 therebetween.

If there is an error regarding control of the linear motion mechanism 40, the stopper cap 198 acts as a mechanical stop, preventing excessive linear motion thereof, in the direction of arrow 214 (FIGS. 1A, 2D, 2H and 2J). Similarly the stopper sleeve 200 acts as a mechanical stop in the direction of arrow 216 (FIGS. 1A, 2D, 2H and 21), with the compressible section 212 compressing to decelerate the linear motion of the linear motion mechanism 40. Notably, arrows 214 and 216 are parallel with the axis X.

During assembly, the nut assembly 72 is mounted to the threaded shaft 70, which is not yet fixed to the die plate 20, and the first rotary housing 78 is fastened to the nut assembly 78 via the fastening element 120. The thrust bearing ring 144 is then mounted on the first rotary housing 78 with the first sleeve 170 subsequently seated thereon. The other thrust bearing ring 145 is mounted on the second rotary housing 126 which is then mounted on the first rotary housing 78. The threaded shaft 70 is then inserted into the opening 53 in the planar member 31 in the direction of arrow 214, until the external annular rim 176 of the first sleeve 170 engages the planar member 31. The large-gear-wheel 46, washer 162 and axial bearing ring 160 are mounted on the threaded shaft 70, in the direction of the arrow represented by the numeral 216, with the large-gear-wheel 46 also engaging the recessed top track 150. The second sleeve 172 is then mounted on the threaded shaft 70 in the direction of arrow 214, until the internal shoulder (not shown) of the small cylindrical portion 192, engages the thrust bearing ring 145 for receipt of linear force. In this position the second sleeve 172 also engages the planar member 31 and is then fixed thereto by bolts (not shown) which are inserted into the apertures 184 of the first flanged portion 182. The threaded shaft 70 is then inserted into the plate 26 in the direction of the arrow represented by the numeral 216, and is bolted (not shown) to the second flanged portion 186 thereof via the apertures 188 formed therein. The stopper cap 198, annular plate 174 and stopper sleeve 200 are then mounted on the threaded shaft 70 and fixed to the components described above. The threaded shaft 70 is then fixed statically to the die plate 20, for example, by welding.

It should be noted that there are a number of elements, such as apertures and recessed tracks, formed in a number of the components described above which are adapted for insertion of roller members (not shown) therein. These members are positioned adjacent to the components having the above-described elements, and allow rotation thereof but serve to restrict unwanted lateral or axial movement thereof, thereby providing a stabilizing effect on the linear motion mechanism. These elements are, namely: the apertures 112 on the flat surface 106 of the tapered portion 98 of the first rotary housing 78; the apertures 140 and 142, on the tapered portion 134 and the level surface 138 of the second rotary housing 126; the circular tracks 71 on the nut housing 72; and the recessed top tracks 150 and recessed bottom tracks 156 of the thrust bearing rings 144 and 145.

It should also be mentioned that both linear motion mechanisms 40 shown in FIG. 1A are identical in construction to the one being described, with the exception that the threaded shaft 70 and nut assembly 72 of one of them is left-hand threaded shaft and nut assembly and the other is right-hand threaded shaft and nut assembly. Furthermore, both linear motion mechanisms 40 have corresponding parts assembled together as described above and are spaced from each other with the axis X therebetween, and hence with the punch 28 disposed therebetween.

It should be noted that, in this example, the punch 28 is at a mid-point between both linear motion mechanisms 40. However in other examples according to a press of the present invention, the punch may not be at an exact mid-point between the mechanisms 40.

Referring now to FIG. 1A, the motor 44 (best seen in FIG. 1C), in this example, is a compact motor, mounted on the plate 26. Additionally the motor 44 is a servo-controlled electric motor, and is associated with a sensor 220 and operated via the control system 18, for providing rotational motion to the linear motion mechanisms 40 via the transmission mechanism 42.

The sensor 220 may be adapted for detection of compaction force and/or displacement of the punch and/or like factors, and transmit such data to the control system or motion mechanism.

The control system 18 is in the form of a graphic user interface 18A having input buttons 18B, however it should be mentioned that the control system 18 may be any computerized system capable of controlling the elements of the press 10 described above.

In operation, a user (not shown) determines what type of powder based part (not shown) is to be made by the press 10 and thus selects an appropriate die 22 which is filled with an appropriate material (not shown) to secure to the die plate 20. The user then selects the appropriate setting for the press 10 via the graphic user interface 18A and/or input buttons 18B of the control system 18, which activates the motor 44 of the motion assembly 16. The rotor element 41 of the motor 44 is thus rotated, causing rotation of the first large-gear-wheel 46 and the second large-gear-wheel 50 via the intermediary elements of the transmission mechanism 42, as described above. The large-gear-wheels (46 and 50) thus provide rotational motion to the linear motion mechanisms 40 which is converted into linear motion of the punch assembly 14 along the axis X, The conversion of the rotational motion to the linear motion of the punch assembly 14 will be described hereinafter. Depending on the direction of rotation of the rotor element 41, punch assembly 14 with the punch 28 will either move in linear motion towards or away from the die plate 20. During linear motion of the punch assembly 14, undesired non-linear motion thereof may be reduced by the guide rods 28. Initially the punch assembly 14 will be positioned, as shown in FIG. 1A, distant from the die plate 20, so that the punch 28 is not in contact with the die 22 or material contained therein (not shown). After the user (not shown) has selected the appropriate setting, as mentioned above, punch assembly 14, and all components held thereby, moves towards the die plate 20 such that the first punch 28 impacts the material in the die 22, thereby compacting it. During compaction of the material, the sensor 220 detects the compaction force and provides feedback to the motor 44, which use the feedback to further move the punch 28 to a position required to create the part specified by the user. When the part is completed, the control system 18 will raise the punch assembly 14 with the punch to its initial, distant, position. The die 22 may be removed from the die plate 20 and the part (not shown) may then be removed from the die 22.

It is also noteworthy to mention, that the above-mentioned steps regarding the insertion of the die 18 and appropriate material, and the consequent removal thereof from the press may, optionally, be part of an automated production system (not shown) as is known in the art.

The conversion of the rotational motion to the linear motion of the punch assembly 14 will be described for simplicity of reading, with regard to the operation of only one of the linear motion mechanisms 40. The large-gear-wheel 46 thus rotates the first rotary housing 78, which in turn rotates the nut assembly 72. The nut assembly 72 thus moves linearly along the threaded shaft 70, in a direction dependent upon the direction of rotation of the large-gear-wheel 46. If the nut assembly 72 moves in the direction of the arrow 216, the first rotary housing 78 correspondingly moves therewith, applying rotational and thrusting force to the second rotary housing 126 via the first cylindrical section 84. The second rotary housing 126 applies these forces to the thrust ring 145 which in turn applies thrusting force only to the internal shoulder (not shown) in the small cylindrical portion 192 of the second sleeve 172. The second sleeve 172 and all of the components fixed thereto, including the plate 26 with the punch 28, are then moved along the threaded shaft 70 together with the nut assembly 72. If the nut assembly 72 moves in the direction of the arrow 214, the first rotary housing 78 correspondingly moves therewith, applying rotational and thrusting force the thrust ring 144 mounted thereon, which in turn applies thrusting force only to the first sleeve element 170. The external annular rim 176 of the first sleeve element 170 in turn thrusts the plate 26 with the punch 28, and all of the components fixed thereto, in the direction of arrow 214.

Another point of note is that the nut assembly 72 used in the linear motion mechanism 40 could be of a recirculating roller screw type, for example sold by the SKF Group under the name “Recirculating roller screw”, in which case the ribbed rollers would be grooved rollers and the force compaction and accuracy of the press would be calculably different. An alternative arrangement to the one described above may be where the nut assemblies are statically joined to the housing assemblies and the threaded shafts, upon which each nut assembly is mounted, is rotated by the large-gear-wheels, causing linear motion of the plate. One of the threaded shafts would therefore be rotated in a clockwise direction and the other would thus be rotated counterclockwise. Such arrangement, in view of this specification, would be able to be carried out by a person skilled in the art of press manufacture.

It can be seen in FIG. 1A, that the frame 12 in fact further comprises: a second axis Y, parallel and adjacent with the first axis X; a second punch assembly 222; and a motion assembly adapted to move the second punch assembly 222 along the second axis Y. Notably, the second punch assembly 222 is inverted with respect to the first punch assembly 14, and is disposed with the die plate 20 therebetween. It should be noted that the operation of the second punch assembly 222 is identical to that of the first punch assembly 14, described above, and that the respective motion assemblies of the first and second punch assemblies may be synchronized.

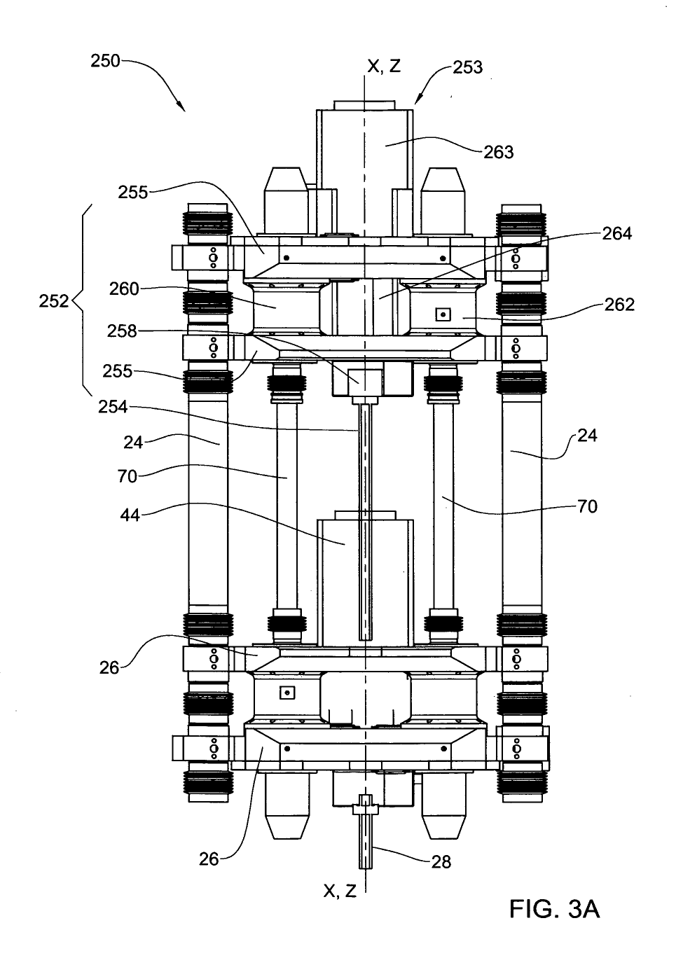

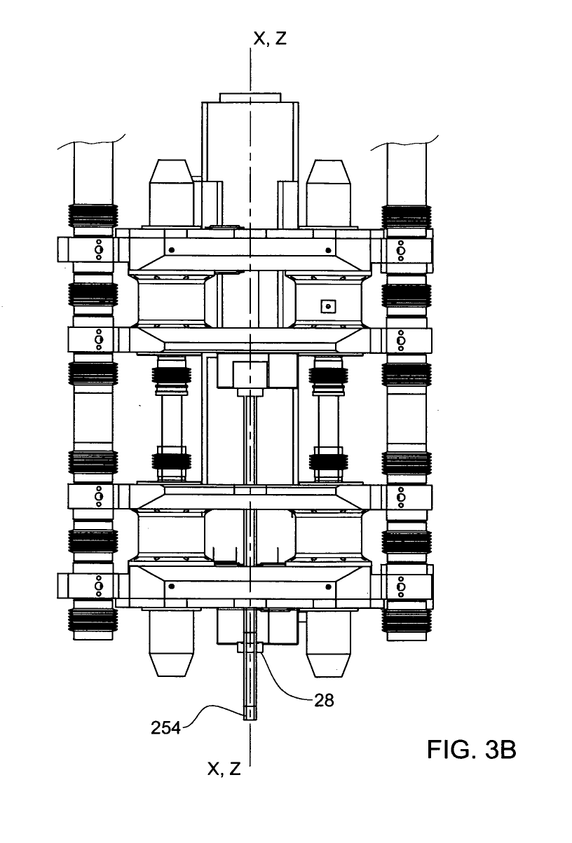

A portion of a further example of a press, generally designated 250, in accordance with the present invention is shown, in FIGS. 3A and 3B. Wherein the press 250 comprises what will be designated as a third axis Z adjacent and parallel with the axis X, a third punch assembly 252 and a third motion assembly 253. It should be mentioned that axis Z is not clearly seen in FIGS. 3A and 3B as it is directly behind axis X. Another difference between this example and the previous example is that the third punch assembly 252 is disposed such that the first punch assembly 14 is between the third punch assembly 252 and the die plate (not shown).

Notably, the first plate 26 has additional concentric central apertures (not shown) formed in both planar members thereof, and slightly spaced from the first punch 28, for reasons which will be explained hereinafter. Additionally, the third punch assembly 252 further comprises: a third plate 255 oriented perpendicular relative to the axis Z and adapted for linear motion therealong; a third punch 254 held by the third punch assembly 252 and disposed above the central apertures (not shown) of the first plate 26; a third sensor 258 associated with the third punch 254; two third linear motion mechanisms 260 and 262 for moving the third punch assembly 252 in linear motion; a third transmission mechanism generally designated 264 engaging the two third linear motion mechanisms 260 and 262; and a third motor 263 mounted on the punch assembly 252, in the form of a servo-controlled electric motor associated with the third sensor 258 and operated via a control system (not shown), for providing rotational motion to the two third linear motion mechanisms 260 and 262 via the third transmission mechanism 264. It should be noted that the third punch 254 is elongated, i.e. longer than the first punch 28 and that the third linear motion mechanisms 260 and 262 share the same threaded shafts 70 with the linear motion mechanism disposed below them, i.e. that the first and third punch assemblies may have collinear linear motion mechanisms, enabling the collinear shafts thereof to be shared.

In operation: the third punch assembly 252 and third motion assembly 253 operate in substantially the same manner described above with regards to the previously mentioned assemblies, with the following points to be noted. Referring first to FIG. 3A, the portion of the press 250 is shown before operation, with the punches 28 and 254 spaced. When the third motor 263 is activated, it moves together with the third punch assembly 252, towards the die plate (not shown), and the third punch 254 penetrates through the central apertures of the first plate 26 (not shown), constituting the operational state as shown in FIG. 3B. Such penetration is achieved by the second punch 254 having an elongated shaped and being positioned so that it may move alongside the first punch 28 without colliding therewith, while still reaching a die (not shown) which via which axis Z passes. Thus, the press shown has multiple assemblies that may be used in synchronized motion to facilitate uniform part density during the production of a part.

As can be appreciated, a press made in accordance with these principles may also have additional punch assemblies, some of which may be inverted about the die plate. Alternatively, the first axis X could have been made to be collinear with the third axis Z, wherein the first punch 28 may have an aperture formed therein to allow the movement of the third punch 254 therethrough. In all of the above described and envisioned examples the motion assemblies may be synchronized with one another.

Those skilled in the art to which this invention pertains will readily appreciate that numerous changes, variations and modifications can be made without departing from the scope of the invention mutatis mutandis.

1. A press comprising a frame having a longitudinal axis; a die for containing therein powdered material to be compacted, mounted on the frame; a punch assembly mounted on the frame; and a motion assembly adapted to move the punch assembly relative to the die along the axis; the punch assembly comprising a plate and a punch held by the plate and extending along the axis; wherein the plate comprises a central portion via which the axis passes and distal portions on two sides of the central portion; the motion assembly comprising two linear motion mechanisms each comprising a threaded shaft with a portion thereof received within one of the distal portions, and a nut assembly mounted on the threaded shaft and engaging the distal portion within which the threaded shaft is received; each nut assembly comprising a nut housing surrounding a portion of the threaded shaft, and a plurality of ribbed rollers disposed therebetween in a planetary arrangement and engaging both; wherein rotational motion provided to either both of the nut assemblies or both of the threaded shafts, causes linear motion of the punch assembly with the punch along the axis, for the compaction of powdered material contained within the die.

2. The press according to claim 1, wherein the nut assembly is a planetary roller screw type and hence the ribbed rollers are threaded rollers.

3. The press according to claim 1, wherein the nut assembly is a recirculating roller screw type and hence the ribbed rollers are grooved rollers.

4. The press according to claim 1, wherein the motion assembly further comprises a single motor adapted to provide the rotational motion.

5. The press according to claim 4, wherein the motor is mounted on the punch assembly and moves therewith.

6. The press according to claim 4, wherein the motor is an electric motor.

7. The press according to claim 4, wherein the motor is servo-controlled.

8. The press according to claim 1, wherein one of the linear motion mechanisms comprises a right-hand threaded shaft and nut assembly, and the other linear motion mechanism comprises a left-hand threaded shaft and nut assembly.

9. The press according to claim 4, wherein said motion assembly further comprises a transmission mechanism adapted for receiving said rotational motion from the motor and transmitting it to both of the linear motion mechanisms.

10. The press according to claim 9, wherein the transmission mechanism is adapted to provide clockwise rotational motion to one of the linear motion mechanisms and counterclockwise rotational motion to the other.

11. The press according to claim 4, wherein the motor is the sole source of the linear motion of the punch assembly.

12. The press according to claim 1, wherein the motion assembly comprises at least one additional linear motion mechanism engaging one of the distal portions of the plate.

13. The press according to claim 1, wherein the frame has a second axis parallel relative to the axis, a second punch assembly and a second motion assembly adapted to move the second punch assembly along the second axis.

14. The press according to claim 13, wherein the second punch assembly comprises two second linear motion mechanisms which are collinear with the linear motion mechanisms of the punch assembly, such that two pairs of collinear linear motion mechanisms are formed, each pair sharing a common threaded shaft.

15. The press according to claim 13, wherein said second punch assembly is inverted with respect to the punch assembly, with said die disposed therebetween.

16. The press according to claim 13, wherein said second punch assembly is disposed such that said punch assembly is disposed between the second punch assembly and the die.

17. The press according to claim 1, wherein the press further comprises a plurality of additional axes, punch assemblies and motion assemblies.

18. A press comprising a frame having at least one longitudinal axis; a die for containing therein powdered material to be compacted, mounted on the frame; at least one punch assembly mounted on the frame; and at least one motion assembly adapted to move the at least one punch assembly relative to the die along the at least one axis; the at least one punch assembly comprising a plate and a punch held by the plate and extending along the at least one axis; wherein the plate comprises a central portion via which the at least one axis passes and distal portions on two sides of the central portion; the at least one motion assembly comprising two linear motion mechanisms each comprising a threaded shaft with a portion thereof received within one of the distal portions, and a nut assembly mounted on the threaded shaft and engaging the distal portion within which the threaded shaft is received; each nut assembly comprising a nut housing surrounding a portion of the threaded shaft, and a plurality of ribbed rollers disposed therebetween in a planetary arrangement and engaging both; wherein rotational motion provided to either both of the nut assemblies or both of the threaded shafts, causes linear motion of the at least one punch assembly with the punch along the at least one axis, for the compaction of powdered material contained within the die.

19. A press comprising a frame having a longitudinal axis; a die for containing therein powdered material to be compacted, mounted on the frame; a punch assembly mounted on the frame; and a motion assembly adapted to move the punch assembly relative to the die along the axis; the punch assembly comprising a plate and a punch held by the plate and extending along the axis; wherein the plate comprises a central portion via which the axis passes and distal portions on two sides of the central portion; the motion assembly comprising two linear motion mechanisms and a single motor adapted to provide rotational motion to both linear motion mechanisms, thereby causing linear motion of the punch assembly with the punch along the axis, for the compaction of powdered material contained within the die.

20. A press according to claim 19, wherein each of the two linear motion mechanisms comprise a threaded shaft with a portion thereof received within one of the distal portions, and a nut assembly mounted on the threaded shaft and engaging the distal portion within which the threaded shaft is received; each nut assembly comprising a nut housing surrounding a portion of the threaded shaft, and a plurality of ribbed rollers disposed therebetween in a planetary arrangement and engaging both.
